(19) United States
(12) Patent Application Publication
(10) Pub. No.: US 2023/0296319 A1
(43) Pub. Date: Sep. 21, 2023

(54) FLAME PROTECTION APPARATUS AND DRYER DRUM COMPRISING SUCH A FLAME PROTECTION APPARATUS

(71) Applicant: Benninghoven Zweigniederlassung der Wirtgen Mineral Technologies GmbH, Wittlich (DE)

(72) Inventors: Matthias Walter Johann, Bad Bertrich (DE); Dietmar Zimmer, Longkamp (DE)

(21) Appl. No.: 18/184,444

(22) Filed: Mar. 15, 2023

(30) Foreign Application Priority Data
Mar. 16, 2022 (DE) 10 2022 202 605.5

(51) Int. Cl. F26B 25/16; F26B 11/02; F26B 21/02

(52) U.S. Cl. CPC F26B 25/16; F26B 11/026; F26B 21/02; E01C 19/05

(57) ABSTRACT

A flame protection apparatus for installation in a dryer drum includes a plurality of sheet metal lamellae that form a ring arrangement about a longitudinal axis. Each sheet metal lamella includes a concave inner contour in a plane perpendicular to the longitudinal axis. On an outer side facing away from the inner contour, an installation member is configured for installing the sheet metal lamella on the dryer drum.

### CROSS-REFERENCE TO RELATED APPLICATIONS

This application claims the priority of German Patent Application, Serial No. DE 10 2022 202 605.5, filed Mar. 16, 2022, the content of which is incorporated herein by reference in its entirety as if fully set forth herein.

### FIELD OF THE INVENTION

The invention relates to a flame protection apparatus for a dryer drum and to a dryer drum comprising such a flame protection apparatus.

### BACKGROUND OF THE INVENTION

For the production of asphalt, recyclable old asphalt material, also called RC material, can be utilized in order to conserve resources. The RC material, which is present in particular as bulk material and in particular as a granulate, is heated in a dryer drum. When leaving the dryer drum, the RC material has a temperature of approximately 120° C. To increase the performance of the dryer drum, the mass throughput through the dryer drum and/or the heat supply can be increased. These measures cause an increase in the pollutant content of the exhaust gas, in particular the content of hydrocarbon compounds (C_{ges}), especially carbon monoxide (CO) and/or carbon dioxide (CO₂). While complying with emission limit values, an increase in performance for the operation of the dryer drum is hardly possible.

### SUMMARY OF THE INVENTION

It is an object of the invention to improve the production of asphalt, and in particular the heating of RC material, and in particular to increase the performance while complying with emission specifications.

This object is achieved by a flame protection apparatus for the installation in a dryer drum, wherein the flame protection apparatus comprises a longitudinal axis and a plurality of sheet metal lamellae which form a ring arrangement with respect to the longitudinal axis and which in each case have a concave inner contour in a plane perpendicular to the longitudinal axis and on an outer side facing away from the inner contour, have an installation member for installing the sheet metal lamella at the dryer drum and by a dryer drum comprising a flame protection apparatus incorporated therein, which is arranged to face a first end wall of the dryer drum. The essence of the invention is that in a dryer drum, which is used for heating RC material, a flame protection apparatus is incorporated by means of which direct flame contact with the RC material is avoided. It has been found that one cause of the increase in emission values with increasing performance in the dryer drum is that the RC material falls into the flame and burns in an uncontrolled manner. The risk of undesirable carbon compounds (C_{ges}) being formed is thus reduced.

In particular, caking of RC material in the dryer drum, in particular on installations in the dryer drum and/or on an inner wall of the dryer drum itself, can be avoided.

The flame protection apparatus minimizes the risk of dust that is present in the dryer drum having direct flame contact. As a result, undesirable emissions can be additionally avoided. Furthermore, the flame protection apparatus prevents direct flame radiation onto the RC material and the associated generation of emissions.

The RC material that is fed to the dryer drum is in particular a bulk material and in particular in granular form. The RC material is also referred to as RC granulate.

The flame protection apparatus according to the invention has a longitudinal axis as well as a ring arrangement that is oriented concentrically to the longitudinal axis and is formed from a plurality of sheet metal lamellae. The sheet metal lamellae are in particular detachably connected to one another. The sheet metal lamellae form a closed ring in the circumferential direction of the longitudinal axis. The ring may have a cylindrical contour or a conical contour with respect to the longitudinal axis, wherein the cone angle is in particular smaller than 10°, in particular smaller than 8°, in particular smaller than 5°, in particular smaller than 3°, in particular smaller than 2°, in particular smaller than 1° and in particular larger than 0.1°.

The sheet metal lamellae are made in particular from sheet metal, in particular from a steel material and in particular from a temperature-resistant and/or heat-resistant stainless steel alloy. In particular, a high-alloy chromium steel, for example having the material number 1.4713, 1.4724, 1.4742, 1.4749, 1.4762, 1.4878, 1.4828, 1.4821, 1.4841 and/or 1.4864, is used for this purpose. A temperature-resistant stainless steel is known under the trademarked trade name Sicromal®.

The sheet metal lamella is in particular designed in one piece and in particular produced in one piece.

In particular a plurality, in particular at least three, in particular at least four, in particular at least six, in particular at least eight, in particular at least ten, in particular at least twelve and in particular at most fifty sheet metal lamellae form a closed ring arrangement. The number of sheet metal lamellae used can be variably determined depending on the size of the dryer drum.

In particular, all sheet metal lamellae of a ring arrangement are designed to be identical. This reduces the production and mounting effort.

The sheet metal lamellae have an inner contour that is concave in a plane perpendicular to the longitudinal axis. In particular, the inner contour is designed without kinks, in particular with a curvature, in particular with a constant curvature and in particular in the form of a circular line segment. With respect to a rotation about the longitudinal axis, the inner contour of the sheet metal lamella has an opening angle of at least 15°, in particular at least 30°, in particular at least 45°, in particular at least 60°, in particular at least 90°, in particular at least 120°, in particular at least 135° and in particular at most 180°.

The sheet metal lamella comprises an installation member which serves to install the sheet metal lamella, in particular in a detachable manner, on the dryer drum, in particular on an inner wall of the dryer drum. The installation member is arranged on an outer side facing away from the inner contour of the sheet metal lamella. The installation member is a mounting member. Each individual sheet metal lamella can be installed and mounted individually in the dryer drum. This simplifies the replacement of a single sheet metal lamella, in particular for maintenance and/or repair purposes.

In particular, the dryer drum can be driven in rotation about an axis of rotation. The flame protection apparatus is in particular installed in the dryer drum in such a manner that the longitudinal axis of the flame protection apparatus and the axis of rotation of the dryer drum are arranged concentrically to one another.

An installation member which is formed in one piece on the sheet metal lamella, in particular as a folded edge, is particularly robust. The production of the installation member is uncomplicated. Joining points for the attachment of the installation member are avoided. In particular, the service life of the sheet metal lamella is increased. In particular, it has been recognized that joining points, in particular welded joints, impair the stability and/or durability of the sheet metal lamella, at least locally, i.e. they weaken it.

An installation member which has a connecting portion which is oriented in particular radially with respect to the longitudinal axis simplifies the assembly and in particular the installation of the sheet metal lamella in the dryer drum. A connecting portion of the installation member is oriented in particular radially to the longitudinal axis and extends in a longitudinal direction which is oriented parallel to the longitudinal axis, i.e. in a radial plane. The connecting portion has in particular at least one, and in particular a plurality of, connecting bores which allow a detachable mounting to a fixed installation in the dryer drum. In particular, a plurality of connecting bores enable a variably fixable mounting position of the sheet metal lamella in the dryer drum. It is advantageous if a distance between in each case adjacent connecting bores is identically fixed.

An installation member which is arranged at the end of the sheet metal lamella in the circumferential direction with respect to the longitudinal axis simplifies the assembly and installation of the sheet metal lamella. In particular, the accessibility for the installation member is improved.

A coupling member which is fastened to the sheet metal lamella for coupling with a sheet metal lamella which is arranged adjacent in the circumferential direction improves the connection of the sheet metal lamellae to the ring arrangement. In particular, a plurality of coupling members are provided for each sheet metal lamella, in particular spaced apart from each other in the axial direction of the longitudinal axis. The coupling members are in particular designed to be finger-like or web-like and serve to couple, in particular to hold, a next sheet metal lamella that is arranged adjacent in the circumferential direction. Sheet metal lamellae which are arranged adjacent to each other in the circumferential direction are arranged to float with respect to one another. This is understood to mean that one sheet metal lamella is in floating contact with the sheet metal lamella that is arranged adjacent to it in the circumferential direction, i.e. that they are movable in particular in the circumferential direction and/or axially and/or radially in relation to one another. The at least one coupling member is not directly fastened to the sheet metal lamella that rests on it, but ensures that the sheet metal lamella that rests on it is held in position in the event of expansion, in particular due to thermal expansion. On the one hand, the at least one coupling member ensures reliable retention of the sheet metal lamella. On the other hand, retaining the sheet metal lamellae by means of the at least one coupling member allows the sheet metal lamellae to move as a result of the thermal load in the dryer drum.

A coupling member which protrudes in the circumferential direction on the sheet metal lamella enables reliable coupling of adjacent sheet metal lamellae.

A sheet metal lamella which has a plurality of sheet metal strips in the circumferential direction with respect to the longitudinal axis, which sheet metal strips are connected to one another in one piece, in particular by bending, is particularly robust and is designed to be uncomplicated. The sheet metal lamella can be produced from a flat sheet metal blank by sheet metal forming, in particular by multiple, in particular sequentially performed folding processes. Alternatively or in addition to folded edges, a concave inner contour of the sheet metal lamella can also be produced by rolling. Due to the production by deformation, the sheet metal lamella has a high stiffness and, in particular, a high stability. The deformation itself results in hardening of the sheet material. A time-consuming primary forming production process is avoided. Joining connections can be dispensed with. A plurality of sheet metal strips are formed on the sheet metal lamella, which sheet metal strips are oriented in particular parallel to one another in each case. In particular, a chamfered connection is provided between two adjacent sheet metal strips, wherein the chamfered connection is made in one piece with a rounding on the inside and on the outside of the sheet metal lamella. A sheet metal lamella of this type thus has a plurality of flat sheet metal strips and rounded chamfered connections between two sheet metal strips. A sheet metal lamella of this type has a concave inner contour, which has a curvature at least in portions and in particular comprises a plurality of curved portions.

Depending on the size of the sheet metal lamella, the number of sheet metal strips can be set differently. In particular, there are at least three, in particular at least four, in particular at least six, in particular at least eight, in particular at least ten and in particular at least twelve sheet metal strips.

A baffle wall which is arranged at a distance from the ring arrangement in the axial direction with respect to the longitudinal axis reduces the risk of the flame radiating deeply along the longitudinal axis into the dryer drum in an unintended manner. In particular, this can prevent the flame from penetrating into a region of the dryer drum where lifter plates are arranged.

A flame protection apparatus comprising a corrugated ring arrangement which is arranged in the axial direction with respect to the longitudinal axis, in particular downstream from the ring arrangement, enables an uncomplicated and in particular direct mounting of the baffle. The baffle is in particular stably and robustly arranged in the dryer drum. In particular, the corrugated ring arrangement is directly fastened to an inner side of the dryer drum. The corrugated ring arrangement is in particular a drum protector installation. The corrugated ring arrangement serves in particular as a protection of the tube of the dryer drum against radiant heat of the burner flame. The RC granulate slides, in particular in the circumferential direction, along the corrugated ring arrangement; there is no axial transport of the RC granulate by means of the corrugated ring arrangement. In particular, the corrugated ring arrangement has no material transport function.

The baffle wall can be fastened to the corrugated ring arrangement. The corrugated ring arrangement forms a stable frame for fastening the baffle wall.

Additionally or alternatively, it is possible to fasten the baffle wall directly to the housing of the dryer drum, i.e. to the drum tube, in particular to the inner side thereof.

In particular, the corrugated ring arrangement is arranged along a heat propagation direction downstream from the at least one ring arrangement in the dryer drum.

A plurality of ring arrangements which are arranged one behind the other in the axial direction with respect to the longitudinal axis, in particular along a heat propagation direction, ensure a reliable shielding of the burner flame. In particular, the individual ring arrangements are designed to be conical and to overlap in regions in the axial direction.

A dryer drum comprising a flame protection apparatus incorporated therein, which is arranged to face a first end wall of the dryer drum, substantially has the advantage of the flame protection apparatus incorporated therein, to which reference is hereby made. The dryer drum is used in particular for drying RC material.

A dryer drum which has a material inlet which is arranged at the first end wall enables efficient drying of the RC material. The dryer drum is in particular operated in a co-current mode.

A dryer drum comprising an incoming air duct arranged at the first end wall enables efficient cooling of the flame protection apparatus. An incoming air duct opens into the dryer drum at a first end wall at which the flame protection apparatus is arranged. In relation to the radial direction of the axis of rotation of the dryer drum, the incoming air duct is arranged inside the flame protection apparatus. A fan, in particular a radial fan, is arranged along the incoming air duct.

In particular, the incoming air duct is guided into the dryer drum and arranged there in such a manner that the incoming air does not interfere with the flame burnout.

A dryer drum configured such that the incoming air duct comprises an exhaust gas recirculation duct which is connected to an exhaust gas side of the dryer drum enables efficient exhaust gas recirculation and an associated reduction of emissions. In particular, an extraction hood is connected to the dryer drum on an exhaust gas side, which extraction hood has, in particular, an integrated particle separation system. Exhaust gases can be recirculated from the extraction hood to the dryer drum via the exhaust gas recirculation line. An exhaust gas discharge line may also be connected to the extraction hood, which exhaust gas discharge line leads in particular to a dust extraction system and/or a chimney in order to discharge purified exhaust gases into the environment.

A dryer drum comprising a dust feed, in particular in the region of the first end wall, in particular adjacent to the material inlet, prevents the risk of undesired caking in the dryer drum. By means of a dust feed, which is arranged in particular in the region of the first end wall and in particular adjacent to the material inlet, the risk of caking of old asphalt granulate can be reduced and in particular prevented. A dust feed comprises the targeted feeding of dust material, in particular filler material, in particular by means of the incoming air duct.

The dust feed can open directly into the dryer drum, so that the dust is fed into the interior of the dryer drum to combine with the old asphalt granulate that has been fed in. Additionally or alternatively, the dust feed can be arranged at the material inlet, i.e. before the old asphalt granulate is fed into the dryer drum, in particular through the end wall of the dryer drum. In this case, the dust can be added to the old asphalt granulate to be fed into the dryer drum. The dust is thus added upstream from the material feed and in particular upstream from the dryer drum and in particular at the material inlet. In addition or alternatively, the dust can also be added upstream from the dryer drum, i.e. before the material is added into the dryer drum.

In particular, so-called coarse filler, i.e. dust particles having an average particle size of at least 63 µm and at most 500 µm, serves as dust for the dust feed. The coarse filler is separated in particular from a pre-separator in a dust extraction unit in an asphalt production system and can be added accordingly to the RC granulate, in particular when it is still cold, in particular before the RC granulate is fed to the dryer drum. Additionally or alternatively, dust can also be added externally.

Both the features set forth in the patent claims and the features indicated in the following examples of embodiments of the flame protection apparatus according to the invention are each suitable, either on their own or in combination with one another, to further design the subject-matter according to the invention. The respective combinations of features do not represent any restriction with regard to the further embodiments of the subject-matter of the invention, but are essentially merely exemplary in character.

### BRIEF DESCRIPTION OF THE DRAWINGS

Further advantageous configurations, additional features and details of the invention will be apparent from the following description of an embodiment example with reference to the drawing.

FIG. 1 shows a schematic sectional illustration of a dryer drum for RC material comprising a flame protection apparatus according to the invention,

FIG. 2 shows a side view of the flame protection apparatus according to FIG. 1,

FIG. 3 shows a sectional illustration according to section line III-III in FIG. 2,

FIG. 4 shows a perspective view of the flame protection apparatus according to FIG. 2,

FIG. 5 shows a perspective, enlarged illustration of a sheet metal lamella of the flame protection apparatus in FIG. 4,

FIG. 6 shows a view of the sheet metal lamella according to arrow VI in FIG. 5,

FIG. 7 shows a view of the sheet metal lamella according to arrow VII in FIG. 6.

### DETAILED DESCRIPTION OF THE DRAWINGS

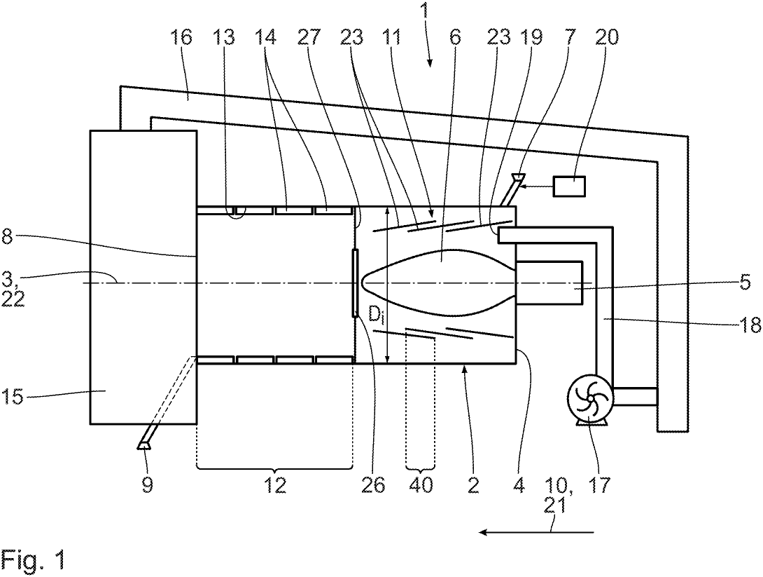

A system designated as 1 in FIG. 1 serves for the production of asphalt, in particular for drying and heating old asphalt granulate, so-called RC material.

The system 1 comprises a dryer drum 2 which can be driven in rotation about an axis of rotation 3. A rotary drive serves this purpose, which is not shown in FIG. 1 for reasons of illustration. In particular, the dryer drum 2 is rotatably mounted by means of pivot bearings, which are not shown in FIG. 1 for reasons of illustration.

The dryer drum 2 is essentially cylindrical with respect to the axis of rotation 3 and has a first end wall 4, which is shown on the right in FIG. 1. A burner 5 is arranged at the first end wall 4 and in particular fastened to the first end wall 4. The burner 5 generates a burner flame 6 which is arranged at least partially inside the dryer drum 2.

At the end facing the first end wall 4, the dryer drum 2 has a material inlet 7 to feed the RC material that is to be dried to the dryer drum 2. Correspondingly, a material outlet 9 is arranged at a second end face 8 of the dryer drum 2 that is opposite the first end wall 4, in order to discharge the dried RC material from the dryer drum 2. In particular, no end wall is arranged at the second end face 8. The dryer drum 2 is designed to be open at the second end face 8. The material outlet 9 is designed in particular without a separate outlet element. In particular, the material outlet 9 is configured in such a manner that the RC material that has been dried in the dryer drum 2 is discharged from the dryer drum 2 via the open second end face 8 and, as a result of gravity, drops into an appropriately positioned silo or a suitable transport container.

A material transport direction 10 is oriented in the dryer drum 2 along the axis of rotation 3 from the first end wall 4 towards the end face 8.

Heat is supplied to the dryer drum 2 by means of the burner 5 and the burner flame 6 generated by the latter. A heat propagation direction 21 is parallel to the axis of rotation 3 and in particular is directed from the first end wall 4 towards the end face 8. The heat propagation direction 21 is in particular identical with the material transport direction 10. The dryer drum 2 is operated in a co-current mode.

The dryer drum 2 can be arranged with the axis of rotation 3 opposite the horizontal with an angle of inclination, in particular between 1° and 10°. The material transport along the material transport direction 10 through the dryer drum 2 is thereby promoted, in particular if the inclination is decreasing towards the end face 8.

In the dryer drum 2, facing the first end wall 4, a flame protection apparatus is arranged, which is identified as a whole by 11. The flame protection apparatus 11 serves in particular to prevent direct contact of the RC material with the burner flame 6. The flame protection apparatus 11 is in particular permanently installed in the dryer drum 2. When the dryer drum 2 is rotated about the axis of rotation 3, the flame protection apparatus 11 is rotated as well.

Along the material transport direction 10, a recirculation portion 12 adjoins the flame protection apparatus 11 in the dryer drum 2. The recirculation portion 12 extends along the axis of rotation 3, in particular from the flame protection apparatus 11 to the end face 8. A plurality of recirculation members 14, in particular in the form of lifter plates, are arranged in the recirculation portion 12 at the inner wall 13 of the dryer drum 2. The recirculation members 14 are in particular fastened directly to the inner wall 13 of the dryer drum 2.

In the region of the flame protection apparatus 11, no recirculation members 14 are arranged. In the region of the flame protection apparatus 11, the dryer drum 2 is designed without lifter plates or at least with drum protectors, which will be explained in more detail later on.

In particular, the flame protection apparatus 11 and the recirculation portion 12 are arranged one behind the other in the dryer drum along the axis of rotation 3 and in particular without any overlap.

An extraction hood 15 is connected to the dryer drum 2 on the end face 8, which forms an exhaust gas side of the dryer drum 2. Emission-laden air is extracted from the dryer drum 2 via the extraction hood 15 and returned to the dryer drum via an exhaust gas recirculation duct 16, a fan 17 and an incoming air duct 18. It is understood that filter members and/or additional fans can be arranged along the ducts 16, 18. In addition, a partial flow of the emission-laden air can be led directly as exhaust gas from the extraction hood 15 and/or a branch line from the exhaust gas recirculation duct 16 can be led into a dust extraction system.

The fan 17 is designed in particular as a radial fan. It is understood that the fan 17 can also be designed as an axial fan. The fan 17 can be designed as a suction or blowing fan.

The incoming air duct 18 opens into the dryer drum 2 at the first end wall 4. In particular, the inlet opening 19 of the incoming air duct 18 is arranged in a radial direction with respect to the axis of rotation 3 between the burner flame 6 and the flame protection apparatus 11.

A storage container 20 can be connected to the material inlet 7. In particular, dust and in particular so-called filler material is stored in the storage container 20. The dust particles of the filler material have an average particle size of at least 63 µm, in particular of at least 100 µm, in particular of at least 200 µm, in particular of at least 300 µm and in particular of at most 500 µm.

Additionally, in the dust extraction system, which is not shown, a pre-separator is arranged in which dust, so-called coarse filler, is separated. This coarse filler can be fed for so-called powdering from the pre-separator of the dust extraction system to the material inlet and/or directly in a region of the material feed into the dryer drum 2, in particular via a chute, a screw conveyor and/or a conveyor fan into an elevator.

In particular, the feed of the coarse filler from the pre-separator of the dust extraction system into the inlet of the elevator thus serves as dust feed. Additionally or alternatively, dust can be fed, in particular from the separate storage container 20.

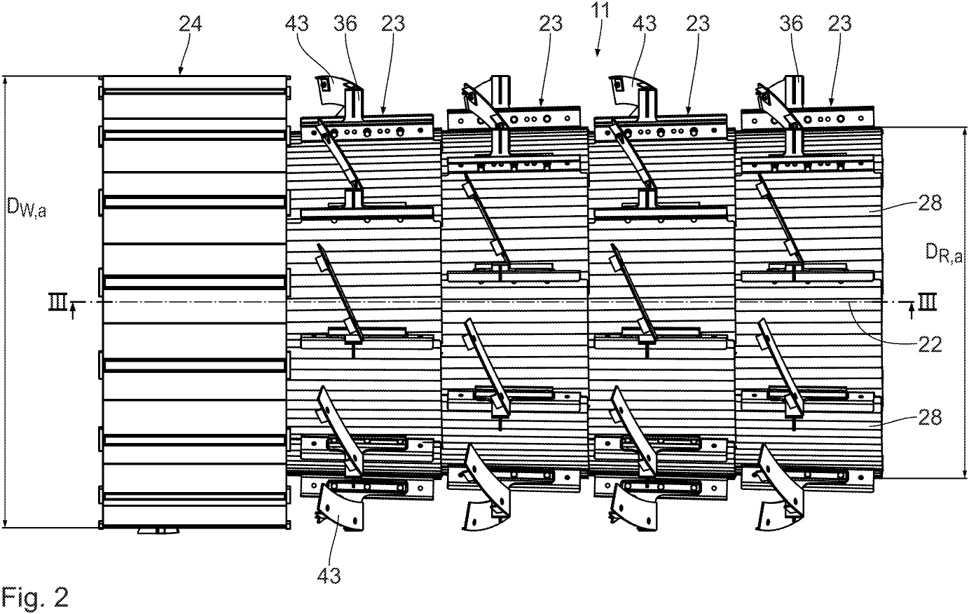

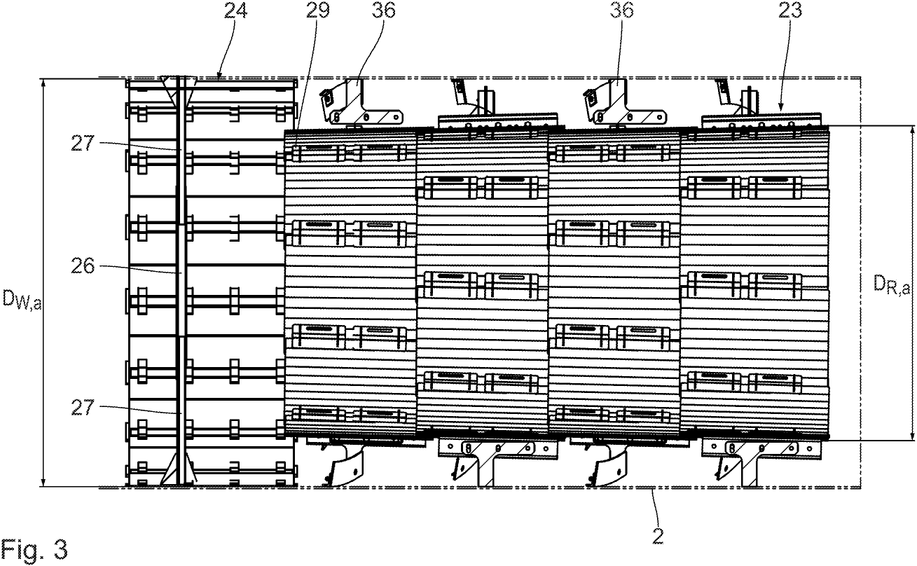

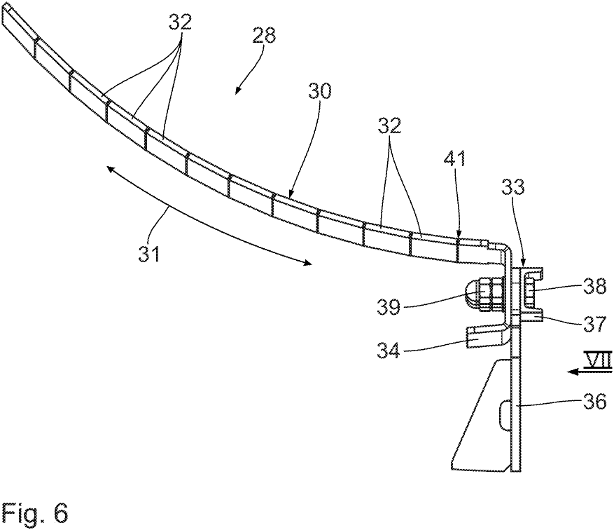

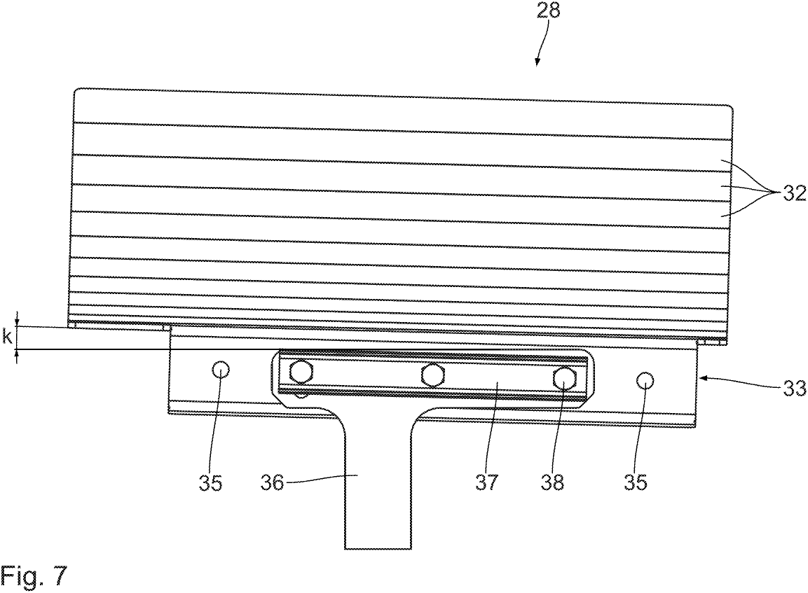

In the following, the flame protection apparatus 11 is explained in more detail with reference to FIGS. 2 to 7. The flame protection apparatus 11 has a longitudinal axis 22 and at least one, in particular multiple, in particular four, ring arrangements 23 that are arranged one behind the other along the longitudinal axis 22. The flame protection apparatus 11 is arranged in the dryer drum 2 in such a manner that the axis of rotation 3 and the longitudinal axis 22 coincide.

In particular, the ring arrangements 23 are each designed identically. According to the embodiment example shown, in each case two ring arrangements 23 that are arranged adjacent to each other along the longitudinal axis 22 are disposed with different angular positions of rotation with respect to the longitudinal axis. A corrugated ring arrangement 24 is arranged along the longitudinal axis 22 after the ring arrangements 23. The corrugated ring arrangement 24 can also be arranged so as to overlap the ring arrangements 23 at least in certain regions and, in particular, so as to overlap them completely. In particular, the corrugated ring arrangement 24 can extend in the axial direction with respect to the longitudinal axis 22 along the length of the flame protection apparatus 11, i.e. in particular up to the first end wall 4. The corrugated ring arrangement 24 is arranged downstream with respect to the ring arrangements 23 referring to the heat propagation direction 21. The corrugated ring arrangement 24 is in particular optional.

Instead of the corrugated ring arrangement 24, individual, in particular unconnected, protective sheets, in particular flat iron, can also be fastened to the inner side of the dryer drum 2.

The ring arrangements 23 each have an outer diameter D_{R,a} which is smaller than an inner diameter Dᵢ of the dryer drum 2. In particular, D_{R,a} < Dᵢ, in particular D_{R,a} ≤ 0.9 x Dᵢ, in particular D_{R,a} ≤ 0.85 x Dᵢ and in particular D_{R,a} ≤ 0.8 x Dᵢ.

The corrugated ring arrangement 24 has an outer diameter D_{W,a} which essentially corresponds to the inner diameter Dᵢ of the dryer drum 2. The outer diameter D_{W,a} is larger than the outer diameter D_{R,a}. In particular, Dw,a > D_{R,a} in particular D_{W,a} ≥ 1.05 x D_{R,a} and in particular D_{W,a} ≥ 1.1 x D_{R,a} applies.

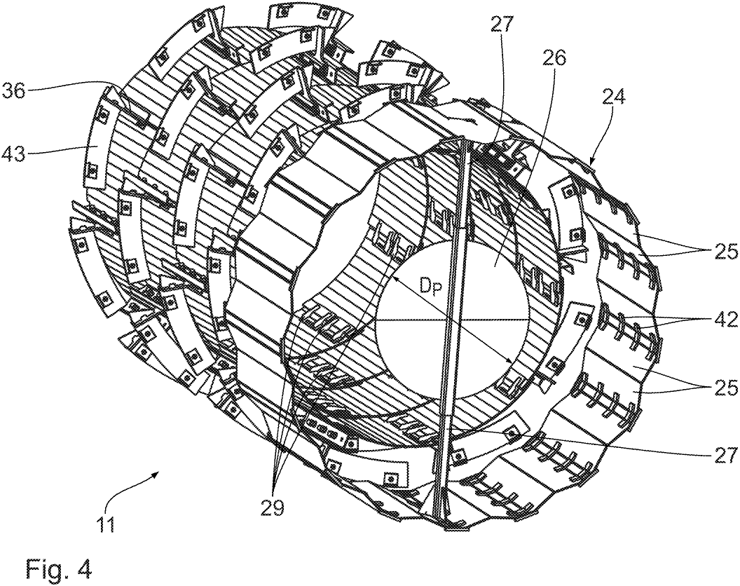

The corrugated ring arrangement 24 comprises a plurality of double sheet metal members 25, eighteen according to the embodiment example shown, each of which is substantially concave with respect to the longitudinal axis 22 and has a substantially V-shaped contour. Each two adjacently arranged double sheet metal members 25 are connected to one another by means of connecting members 42 arranged in the circumferential direction, whereby the closed corrugated ring arrangement 24 is formed and has a corresponding corrugated ring contour, which can be seen in particular in FIG. 4. The corrugated ring arrangement 24 is particularly rigid and has a high stability. The risk of geometric deformation of the corrugated ring arrangement 24 due to increased temperature changes is reduced.

An optional baffle wall 26 is fastened to the corrugated ring arrangement 24. The baffle wall 26 is disc-shaped and has a circular contour. The baffle wall 26 has a surface normal which is oriented parallel to the longitudinal axis 22.

The baffle wall 26 is in particular made of a metal sheet. The baffle wall 26 is retained on the corrugated ring arrangement 24 by means of at least one transverse strut 27. According to the embodiment example shown, two transverse struts 27 are present. There may also be more, in particular at least three, transverse struts 27. The transverse struts 27 serve to provide additional transverse stiffening of the corrugated ring arrangement 24. The transverse struts 27 are arranged transversely and, in particular, vertically with respect to the longitudinal axis 22. The transverse struts 27 are arranged diametrically opposite with respect to the longitudinal axis 22.

The baffle wall 26 has a diameter D_{P} which is smaller than the diameter D_{W,a} of the corrugated ring arrangement 24. In particular, the diameter D_{P} of the baffle wall 26 is less than 90% of the inner diameter Dᵢ of the dryer drum 2 and in particular less than 80% of the inner diameter Dᵢ of the dryer drum 2. In particular, D_{P} ≤ 0.75 x Dᵢ, in particular D_{P} ≤ 0.7 x Dᵢ, in particular D_{P} ≤ 0.6 x Dᵢ, in particular D_{P} ≤ 0.5 x Dᵢ and in particular D_{P} ≥ 0.3 x Dᵢ.

The baffle wall 26 is arranged approximately centrally at the corrugated ring arrangement 24 with respect to the longitudinal axis 22. The baffle wall 26 serves as an axial end member of the flame protection apparatus 11, which axial end member is essentially of hollow cylindrical design.

The ring arrangements 23 each comprise several sheet metal lamellae 28, in particular of identical design. According to the embodiment example shown, each ring arrangement 23 comprises eight sheet metal lamellae 28. Sheet metal lamellae 28 that are adjacent in the circumferential direction 31 are detachably connected to each other. Finger-like coupling members 29, which protrude in the circumferential direction 31 around the longitudinal axis 22 on the sheet metal lamellae 28, are used for this purpose in order to simplify coupling with the respective adjacent sheet metal lamella 28. The coupling members 29 can be used to push one sheet metal lamella 28 onto the respective adjacent sheet metal lamella 28.

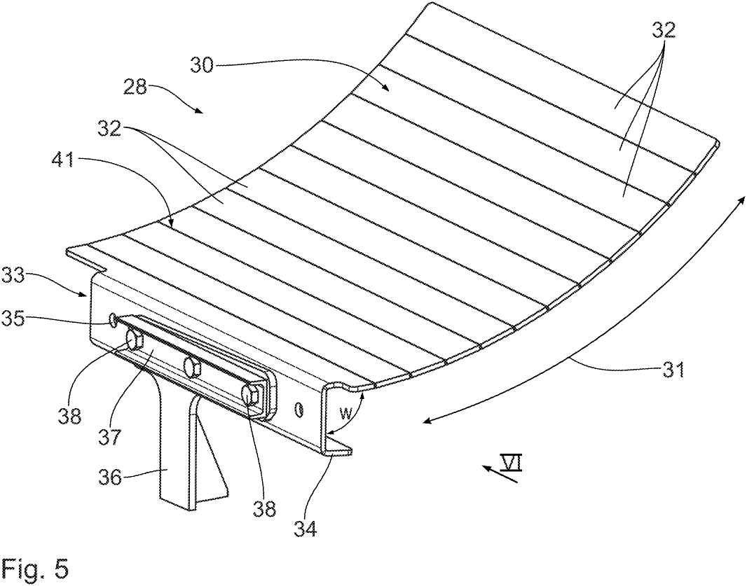

The structure of the sheet metal lamellae 28 is explained in more detail below with reference to FIGS. 5 to 7.

In particular, the sheet metal lamella 28 is made in one piece as a whole and in particular is made from a sheet metal blank by deformation. The sheet metal lamella 28 has a concave inner contour 30, which is curved at least in portions according to the embodiment example shown. The inner contour 30 can also be continuously curved, in particular as a circular line segment.

The inner contour 30 is formed in particular by a plurality of sheet metal strips 32 that are arranged next to one another in the circumferential direction 31. The sheet metal strips 32 are connected to each other in one piece and formed from a one-piece sheet metal blank, in particular by chamfering. A chamfered connection 41 is formed in each case between two sheet metal strips 32 that are adjacent in the circumferential direction 31. The chamfered connection 41 has a chamfered radius that faces the inner contour 30 and is concave.

The sheet metal lamella 28 comprises an installation member 33 which is formed in one piece on the sheet metal lamella 28. In particular, this avoids joining connections, in particular welded connections, for fastening installation members to the sheet metal lamella. The service life and in particular the high temperature resistance of the sheet metal lamella 28 is thus increased.

The installation member 33 is arranged at the end of one of the sheet metal strips 32 in the circumferential direction 31. The installation member 33 is designed as a folded edge, in particular having a folding angle w of 90° with respect to the sheet metal strip 32.

The installation member 33 thus extends essentially as a transverse web to the sheet metal strip 32 on which the installation member 33 is moulded. At an end opposite to the sheet metal strip 32, a stabilizing web 34 is formed on the installation member 33. Due to the stabilizing web 34 and the sheet metal strip 32 arranged opposite to the installation member 33, the installation member 33 essentially obtains the shape of a U-profile or an open rectangular profile. The installation member 33 has a high inherent stability and stiffness.

The installation member 33 has a connecting portion which, according to the embodiment example shown, is essentially formed by a plurality of, in particular five, connecting bores 35. The connecting bores 35 are arranged in the transverse web of the installation member 33 and enable the sheet metal lamella 28 to be detachably connected to an installation member 33 on the dryer drum 2.

For the installation, a mount 36 is arranged on the inner wall 13 of the dryer drum 2 and is in particular firmly attached, in particular welded, to the inner wall 13 of the dryer drum 2. The mount 36 extends in particular in a radial direction with respect to the inner wall 13 and has a coupling portion 37 having a plurality of openings which can be arranged in alignment with the connecting bores 35. According to the embodiment example shown, the mount 36 is connected to the installation member 33 by means of a retaining bar 37, fastening screws 38 that are passed through the connecting bores 35 and fastening nuts 39 that cooperate therewith.

The sheet metal lamellae 28 are each designed with a cone angle k relative to the mount 36. Accordingly, the respective ring arrangements 23 have a conicity which is exaggeratedly shown in FIG. 1. It is essential that the ring arrangements 23 taper conically in the heat propagation direction 21, i.e. towards the baffle wall 26. Along the longitudinal axis 22, the ring arrangements 23 may be arranged in an overlapping manner. In an overlap region 40, a radial gap may result which extends in particular in the circumferential direction 31, in particular fully circumferentially. The overlap region 40 extends along the longitudinal axis 22 over at most 20% of the axial extension of a ring arrangement 23, in particular over at most 15%, in particular over at most 10% and in particular over at most 5%. The overlap region 40 can also be omitted. In this case, the ring arrangements 23 are arranged without overlap with respect to the longitudinal axis 22.

The sheet metal lamellae 28 are arranged in the circumferential direction 31 in such a manner that they rest against each other in the circumferential direction. The design of the ring arrangement 23 is thus inherently stiffened and designed to be particularly robust.

A material deflector sheet 43 is arranged on each of the outer sides of the sheet metal lamella 28 and is fastened in particular to the sheet metal lamella 28. The material deflector sheets 43 are arranged upstream from the mounts 36 with respect to the material transport direction 10. This means that the mounts 36 are each arranged in a shadow region formed by the material deflector sheets 43 with respect to the material transport. As a result, the mounts 36 are protected by the material deflector sheets 43, in particular from RC granulate in the dryer drum 2. The material deflector sheets 43 are optional.

It is also conceivable that the material deflector sheets 43 are attached directly to the mount 36.

For reasons of illustration, the material deflector sheets 43 are not shown in FIGS. 5 to 7.

In the following, with reference to the figures, a method for drying RC material in system 1 is explained in more detail.

In order to dry RC material, heat is supplied to the dryer drum 2 by the burner 5 and the burner flame 6, which spreads along the heat propagation direction 21. The dryer drum 2 is operated in a co-current mode by feeding RC material via the material inlet 7 and discharging dried RC material via the material outlet 9. The resulting exhaust gases are discharged from the dryer drum 2 into the extraction hood 15. There, larger particles can be separated, in particular by means of an integrated particle separation unit. In addition or alternatively, particle separation can also be achieved passively by reducing the flow velocity of the exhaust gases within the extraction hood 15 due to the size of the installation space of the extraction hood 15, so that larger particles are separated by gravity and in particular automatically.

Emission-laden exhaust gas is recirculated into the dryer drum 2 via the exhaust gas recirculation duct 16, the fan 17 and the incoming air duct 18.

The recirculated air is used to cool the flame protection apparatus 11 in the dryer drum 2.

The flame protection apparatus 11 serves to protect the RC material. In particular, the RC material is prevented from having direct flame contact, i.e. in particular from falling through the flame 6. In particular, direct radiation contact between the RC material and the flame 6 is minimized. The baffle wall 26, which provides axial radiation protection for the burner flame 6, also serves this purpose.

Due to the fact that the RC material, which is fed to the dryer drum 2 at the material inlet 7, is loaded by means of coarse filler either from the pre-separator of the dust extraction system and/or from the storage container 20, i.e. is powdered, the formation of agglomerates is prevented. This means that dry dust deposits on the comparatively moist and/or sticky surface of the fed RC material, thereby preventing the RC material from sticking to the inner wall 13 of the dryer drum 2.

What is claimed is:

1. A flame protection apparatus for installation in a dryer drum, the flame protection apparatus comprising:
a plurality of sheet metal lamellae that form a ring arrangement about a longitudinal axis,
wherein each sheet metal lamella of the plurality of sheet metal lamellae includes a concave inner contour in a plane perpendicular to the longitudinal axis and
on an outer side facing away from the inner contour, an installation member configured for installing the sheet metal lamella on the dryer drum.

2. The flame protection apparatus of claim 1, wherein the installation member is integrally formed as one piece with the sheet metal lamella.

3. The flame protection apparatus of claim 2, wherein the installation member is formed as a folded edge.

4. The flame protection apparatus of claim 1, wherein the installation member includes a connecting portion oriented with respect to the longitudinal axis.

5. The flame protection apparatus of claim 4, wherein the connecting portion is oriented radially with respect to the longitudinal axis.

6. The flame protection apparatus of claim 1, wherein the installation member is arranged at an end of the sheet metal lamella in the circumferential direction with respect to the longitudinal axis.

7. The flame protection apparatus of claim 1, further including at least one coupling member fastened to the sheet metal lamella for coupling with another sheet metal lamella arranged adjacent in the circumferential direction.

8. The flame protection apparatus of claim 7, wherein the at least one coupling member protrudes in the circumferential direction on the sheet metal lamella.

9. The flame protection apparatus of claim 1, wherein the sheet metal lamella includes a plurality of sheet metal strips in the circumferential direction with respect to the longitudinal axis, wherein the sheet metal strips are connected to one another in one piece.

10. The flame protection apparatus of claim 9, wherein the sheet metal strips are connected to one another by bending.

11. The flame protection apparatus of claim 1, further including a baffle wall arranged at a distance from the ring arrangement in the axial direction with respect to the longitudinal axis.

12. The flame protection apparatus of claim 1, further including a corrugated ring arrangement arranged in the axial direction with respect to the longitudinal axis.

13. The flame protection apparatus of claim 12, wherein the corrugated ring arrangement is arranged downstream from the ring arrangement.

14. The flame protection apparatus of claim 1, wherein the ring arrangement is a first ring arrangement, and further including a second ring arrangement positioned to one side of the first ring arrangement in the axial direction with respect to the longitudinal axis.

15. The flame protection apparatus of claim 14, wherein the first and second ring arrangements are arranged along a heat propagation direction.

16. A dryer drum comprising the flame protection apparatus of claim 1 positioned to face a first end wall.

17. The dryer drum of claim 16, further including a material inlet arranged at the first end wall.

18. The dryer drum of claim 16, further including an incoming air duct arranged at the first end wall.

19. The dryer drum of claim 18, wherein the incoming air duct includes an exhaust gas recirculation duct connected to an exhaust gas side of the dryer drum.

20. The dryer drum of claim 16, further including a dust feed.

21. The dryer drum of claim 20, wherein the dust feed is located in the region of the first end wall.

22. The dryer drum of claim 20, wherein the dust feed is located adjacent to the material inlet.
